(19) United States
(12) Patent Application Publication
(10) Pub. No.: US 2015/0192366 A1
(43) Pub. Date: Jul. 9, 2015

(54) Modular Water-Cooled Aftermarket Upgrade to an Existing Air Conditioner

(71) Applicant: Lloyd George Allred, Las Vegas, NV (US)

(72) Inventor: Lloyd George Allred, Las Vegas, NV (US)

(21) Appl. No.: 14/149,630

(22) Filed: Jan. 7, 2014

(51) Int. Cl. F28C 3/08; F25D 17/06; B23P 15/26; F25D 17/02

(52) U.S. Cl. CPC F28C 3/08; F25D 17/02; F25D 17/06; B23P 15/26

(57) ABSTRACT

A system and method for a hybrid air conditioning system are provided. The system includes an outside heat exchanger of an independent air conditioning unit, an evaporative cooler cabinet partially surrounding and coupled in serial flow communication with the outside heat exchanger, the evaporative cooler cabinet including one or more evaporative cooling panels, an exhaust fan configured to draw a flow of ambient air through the outside heat exchanger and the one or more evaporative cooling panels, and a water supply configured to supply water to the one or more evaporative cooling panels while the exhaust fan is operating.

### BACKGROUND OF THE INVENTION

1. Field of the Invention

Embodiments of the invention relate to methods and apparatus directed to providing cooled air, directed to a variety of applications, including, but not restricted to, home air conditioning, business, manufacturing, and industrial facilities.

2. Background Art

Swamp cooling or evaporative cooling technology is inexpensive compared to conventional refrigerant-based air conditioning technology. In hotter climates, including most of the Americas, many people find swamp cooling insufficient to provide the cooling and humidity levels required for human comfort. They therefore choose to use refrigerated air conditioning systems despite their much higher operating costs due to their electrical energy requirements.

With soaring energy costs, devices and/or systems that can reduce energy consumption, costs, and the greenhouse gases associated with energy generation are considered to be useful to both the consumer and the environment.

### BRIEF DESCRIPTION

In one aspect, a hybrid air conditioning system includes an evaporative cooler cabinet configured to partially surround an outside heat exchanger of an independent air conditioning unit and coupled in serial flow communication with the outside heat exchanger, the evaporative cooler cabinet including one or more evaporative cooling panels, an exhaust fan configured to draw a flow of ambient air through the outside heat exchanger and the one or more evaporative cooling panels, and a water supply configured to supply water to the one or more evaporative cooling panels while the exhaust fan is operating.

In another aspect, a method of forming a hybrid air conditioning system includes removing an exhaust fan from an outside heat exchanger of an independent air conditioning unit, the exhaust fan having a first airflow rating, replacing the exhaust fan with a replacement exhaust fan, the replacement exhaust fan having a second airflow rating, the second airflow rating greater than the first airflow rating, coupling one or more evaporative cooling panel to the outside heat exchanger spaced from the outside heat exchanger in an upstream direction, and coupling a supply of water to the evaporative cooling panel.

In yet another aspect, an air conditioning system conversion kit includes a frame configured to surround an outside heat exchanger of an independent air conditioning unit wherein the frame includes a cabinet top member including an aperture configured to permit a flow of exhaust air therethrough, a plurality of base members, each including a water reservoir, a plurality of corner struts configured to abut a corresponding one of the plurality of base members, a plurality of end plug members, a side support frame configured to couple between adjacent corner struts and to the cabinet top member, the side support frame including an aperture, an upper distribution reservoir, and a lower collection trough, an evaporative cooling panel configured to mount within the aperture of the side support frame, the evaporative cooling panel including a planar mat of fill material, the mat of fill material configured to receive a flow of water from the upper distribution reservoir and to permit the flow of water to flow parallel to a plane of the mat by gravity; the mat material configured to receive a flow of air from ambient directed to flow perpendicularly with respect to the mat, an exhaust fan configured to draw a flow of ambient air through the outside heat exchanger and the mat, and a water supply configured to supply water to the mats.

### BRIEF DESCRIPTION OF THE SEVERAL VIEWS OF THE DRAWINGS

FIG. 1 depicts the top view of the Cabinet Top Module (cover) for the modular evaporative cooler cabinet.

FIG. 2 depicts the side view of the Cabinet Top Module.

FIG. 3 depicts a three-dimensional view of the Cabinet Top Module.

FIG. 4 depicts the front view of the Cooling Pad Module.

FIG. 5 depicts the rear view of a typical Modular Cooling Pad Panel.

FIG. 6 depicts a three-dimensional view of a typical Modular Cooling Pad Panel.

FIG. 7 depicts a three-dimensional view of a typical Side Support Module, when viewed from the rear.

FIG. 8 depicts the front view of a typical Side Support Module.

FIG. 9 depicts the side view of a typical Modular Cooling Pad Panel.

FIG. 10 depicts the side view of a typical Side Support Module.

FIG. 11 depicts the side view of a typical Corner Strut Module.

FIG. 12 depicts a three-dimensional view of a typical Corner Strut Module.

FIG. 13 depicts the top view of a typical Corner Strut Module.

FIG. 15 depicts the end view of a typical Corner Base Module.

FIG. 16 depicts the side view of a typical End Plug Module.

FIG. 17 depicts a three-dimensional view of a typical End Plug Module.

FIG. 18 presents a photo of the second prototype of the system.

FIG. 19 presents a photo of another view of the second prototype, showing a shortened Cooling Pad Module.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems including one or more embodiments of the disclosure. As such, the drawings are not meant to include all conventional features known by those of ordinary skill in the art to be required for the practice of the embodiments disclosed herein.

### DETAILED DESCRIPTION

The following detailed description illustrates embodiments of the disclosure by way of example and not by way of limitation. It is contemplated that the disclosure has general application to mechanical and methodical embodiments of improving cooling of a refrigerant-based air conditioner using an evaporative cooling pre-cooling stage in industrial, commercial, and residential applications.

Embodiments of a multi-stage air conditioning system are described herein. In one embodiment, an upgrade to an existing air conditioning system is provided. The multi-stage air conditioning system is configured to reduce the temperature of the air entering an outside heat exchanger of a conventional refrigerant-based air-conditioning system using an evaporative cooling unit coupled in serial flow arrangement with the outside heat exchanger. Such an arrangement provides substantially greater cooling of the refrigerant as it passes through the outside heat exchanger, providing significantly colder refrigerant to the indoor heat exchanger than would be provided if the evaporative unit were not attached.

By using inexpensive evaporative cooler technology to pre-cool the air sent through a typical outside heat exchanger, the amount of energy required to cool a home or other building can be greatly reduced.

In one embodiment, starting with the outside heat exchanger of a conventional air conditioner, modifications are made to the electronic components and exhaust fan to handle the increased workload of blowing air through an evaporative cooler's cooling pads in addition to the air conditioner's heat exchanger. Changes are then made to the electronic components to provide an electrical power source that switches on and off simultaneously with the air conditioner. This power source is used, for example, but, not limited to, to power a water pump in the modified evaporative cooler.

The evaporative cooler cabinet is then modified so that it can physically wrap around the outside heat exchanger of the air conditioner. The evaporative cooling unit is then modified by removing the squirrel cage and motor (these are not used), which in turn creates the space for the enclosed heat exchanger. The water pump of the evaporative cooler is then connected to the electrical power source. The evaporative cooler cabinet is coupled in flow communication to a water source. This system provides after-market upgrades to existing air conditioning units to improve their efficiency and reduce operating costs.

For example, under dry conditions when the outside temperature is less than 100° F., the evaporatively cooled air is less than 70° F. This feature has the potential of providing virtually free conditioned air throughout the dry portion of the American Southwest when the outside air temperature is less than 100° F. This feature could prove very attractive in very large commercial systems. With the exception of power used to drive the various air fans, the conditioned air would be virtually free.

The cabinet of the evaporative unit includes mainly bent metal sheets with various holes and/or cut-outs. The cabinet components can be manufactured in standard sizes which can be modified during installation as needed to be compatible with outdoor heat exchangers of varying size.

The evaporative cooling and refrigerant-based cooling hybrid air conditioning system maintains the air conditioner and the evaporative unit as two separate devices. This overcomes repair and maintenance obstacles presented by older failed hybrid units as repairs to both devices can be made by technicians in the field of air-conditioning maintenance. By maintaining the concept that the evaporative unit and existing air conditioning unit are two separate devices, repair technicians are no longer presented with the work challenges presented by single unit hybrid systems.

The following description refers to the accompanying drawings, in which, in the absence of a contrary representation, the same numbers in different drawings represent similar elements.

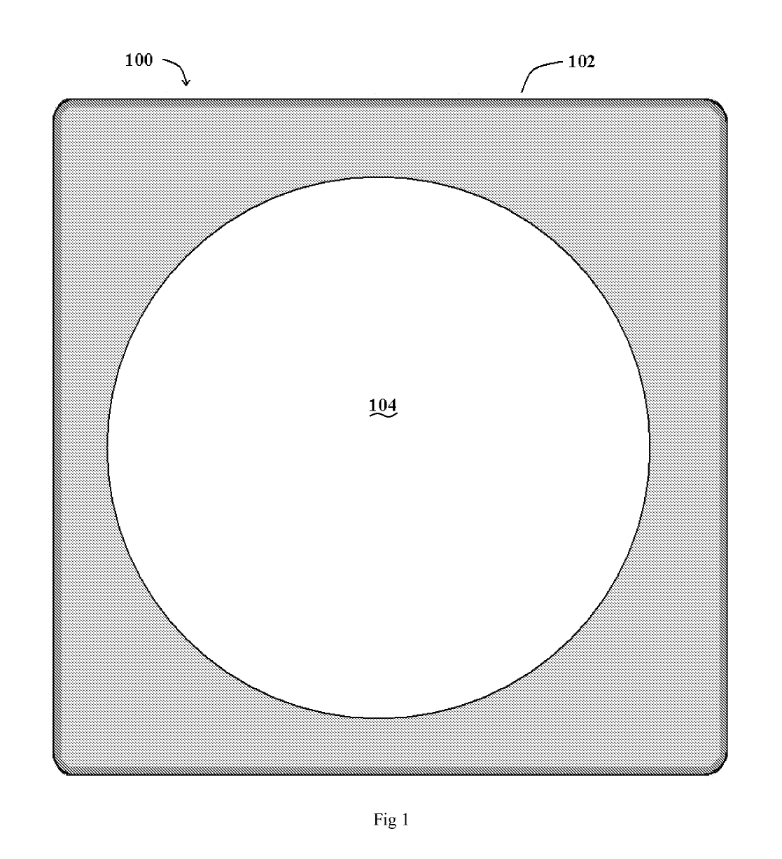

FIG. 1 depicts a top view 100 of a Cabinet Top Module 102 (cover) for a modular evaporative cooler cabinet (not shown in FIG. 1). A central hole 104 allows air to escape from an exhaust fan (not shown in FIG. 1) of an outside heat exchanger (not shown in FIG. 1).

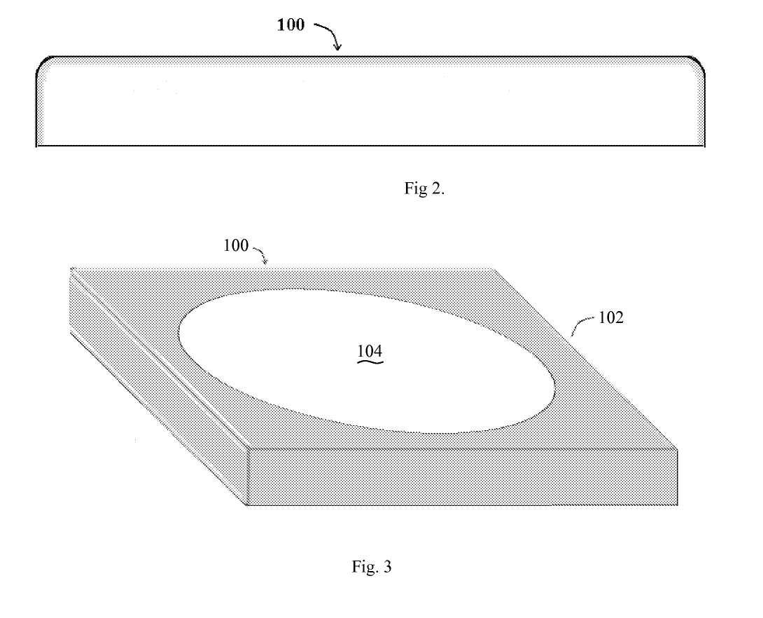

FIG. 2 depicts a side view of Cabinet Top Module 102 (shown in FIG. 1).

FIG. 3 depicts a three-dimensional view of Cabinet Top Module (shown in FIG. 1).

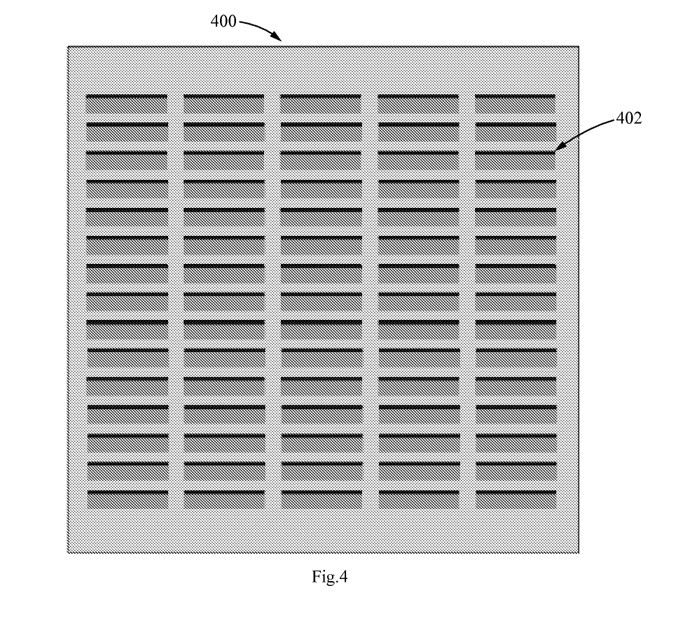

FIG. 4 depicts a front view of a Cooling Pad Panel 400. In the example embodiment, Cooling Pad Panel 400 is adjustable for compatibility with evaporative cooler cabinets (not shown in FIG. 4) of various sizes by trimming one or more of the cooling vent columns 402. By shortening or trimming, the Cooling Pad Panels are made to fit around existing hardware and pipes associated with the outside heat exchanger (not shown in FIG. 4).

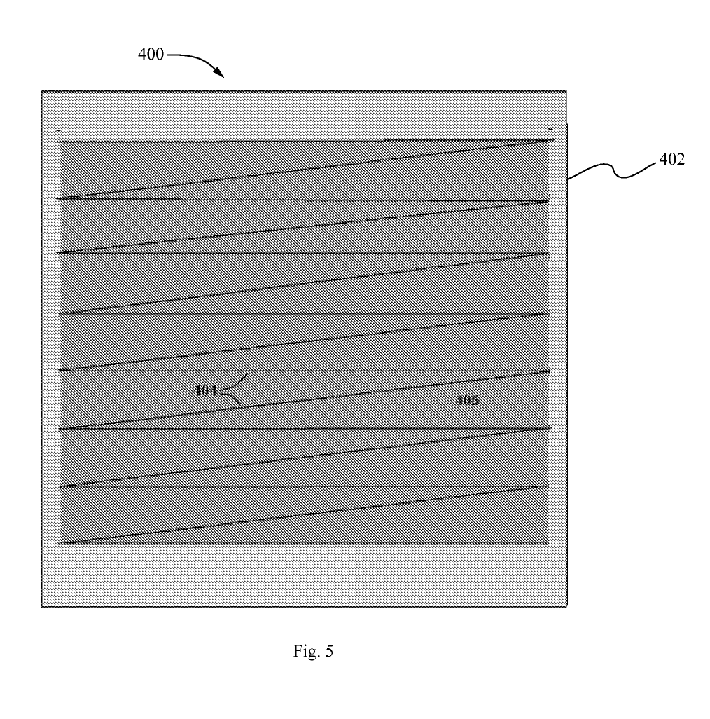

FIG. 5 depicts a rear view of Modular Cooling Pad Panel 400 in accordance with an example embodiment of the present disclosure. A rear side 402 of Cooling Pad Panel 400 is normally not visible, because it faces inwardly towards an outside surface of the outside heat exchanger. Retaining cords 404 are used to secure one or more cooling pads 406 against rear side 402.

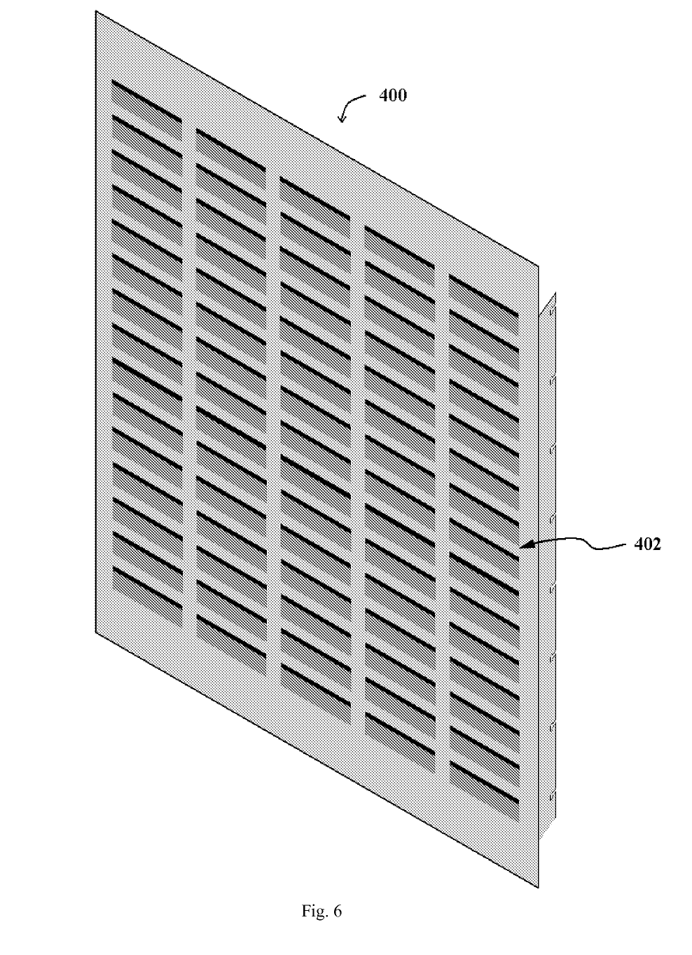

FIG. 6 depicts a three-dimensional view of Cooling Pad Panel 400 (shown in FIG. 4).

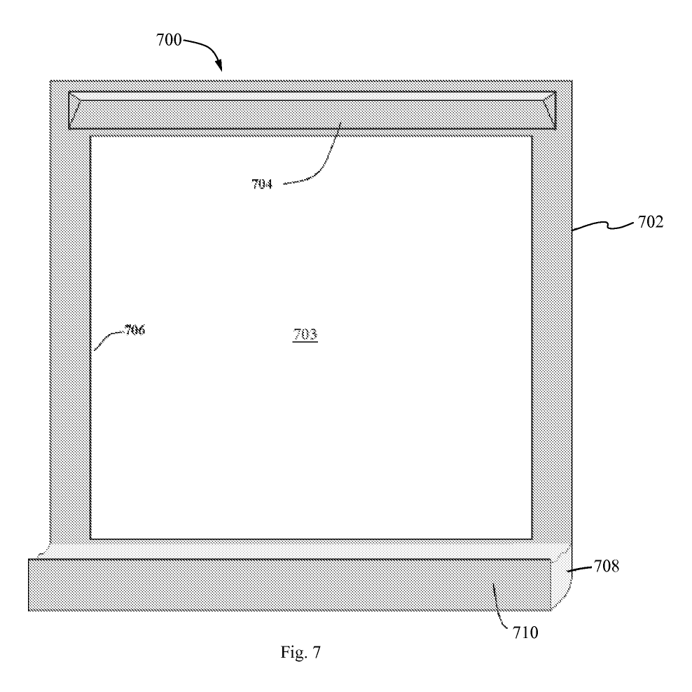

FIG. 7 depicts a three-dimensional view of a Side Support Module 700 having an inner surface 702. A central hole 703 is provided, with dimensions slightly smaller than Cooling Pad Panel 400. A distribution trough 704 extends along an upper edge of central hole 703 to distribute water approximately evenly across one or more cooling pads 406. A bottom edge of Cooling Pad Panel 400 (shown in FIG. 4) slips inside Side Support Module 700, whereas two sides 706 of Cooling Pad Panel 400 lie in front of Side Support Module 700. In various embodiments, Cooling Pad Module 400 is attached to Side Support Module 700 with several screws along the side. A trough 708 for retaining water after it drips down from cooling pad 406 is formed using a lower edge 710 of Side Support Module 700 that is curled up or bent (as depicted in the drawing).

FIG. 8 depicts a front view of Side Support Module 700 in accordance with an example embodiment of the present disclosure. In the example embodiment, central hole 403 is rectangularly-shaped and configured to receive Cooling Pad Panel 400 mounted therein.

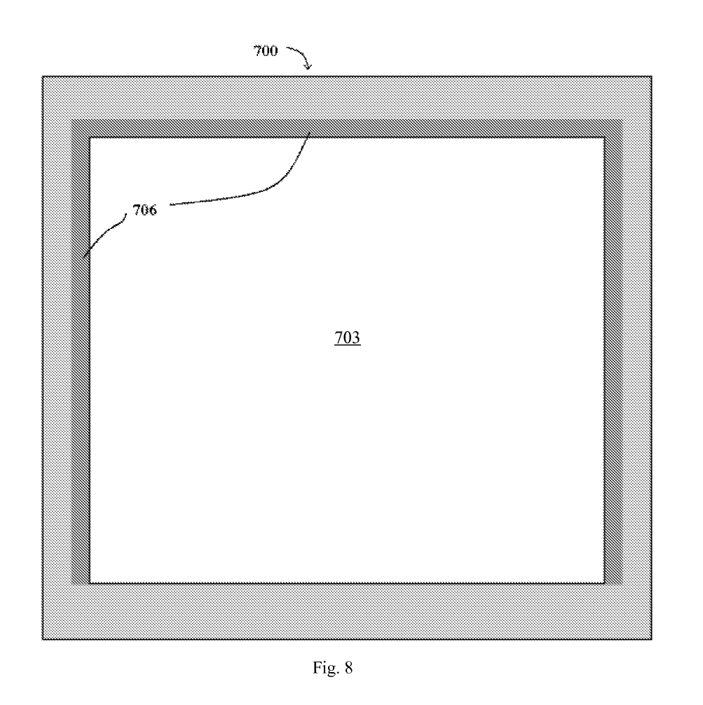

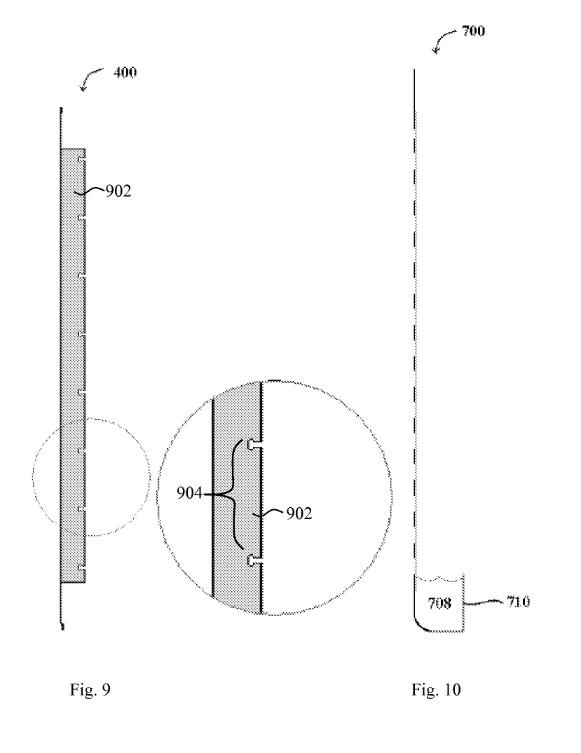

FIG. 9 depicts a side view of Cooling Pad Panel 400. A metal flange 902 is equipped with notches 904 for stringing weather-resistant cord 404 (shown in FIG. 4) to retain cooling pads 406. Conventional evaporative coolers use a metal retainer for retaining the cooling pads 406. The use of cord 404 reduces a fabrication cost and time.

FIG. 10 depicts the side view of Side Support Module 700 in accordance with an example embodiment of the present disclosure.

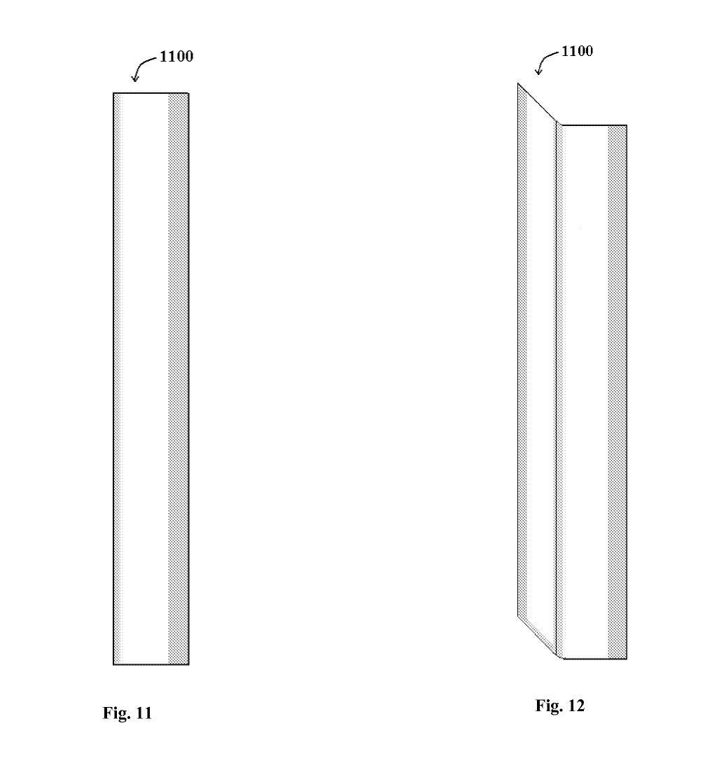

FIG. 11 depicts a side view of a Corner Strut Module 1100.

FIG. 12 depicts a three-dimensional view of Corner Strut Module 1100.

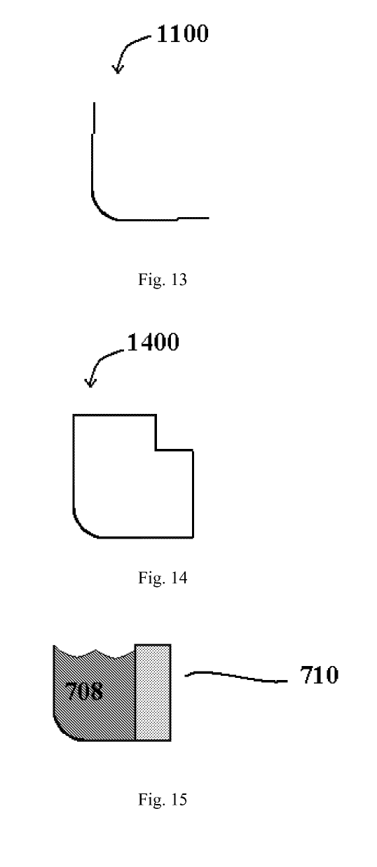

FIG. 13 depicts a top view of a Corner Strut Module 1100 in accordance with an example embodiment of the present disclosure. In the example embodiment, Corner Strut Module 1100 is formed of curved sheet metal, which is configured to be very sturdy, capable of carrying loads in excess of several hundred pounds, which is more than sufficient to protect the outside unit.

FIG. 14 depicts top view of a Corner Base Module 1400.

FIG. 15 depicts an end view of Corner Base Module 1400.

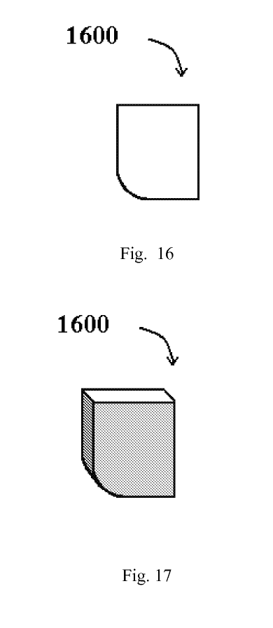

FIG. 16 depicts a side view of an End Plug Module 1600.

FIG. 17 depicts a three-dimensional view of End Plug Module 1600.

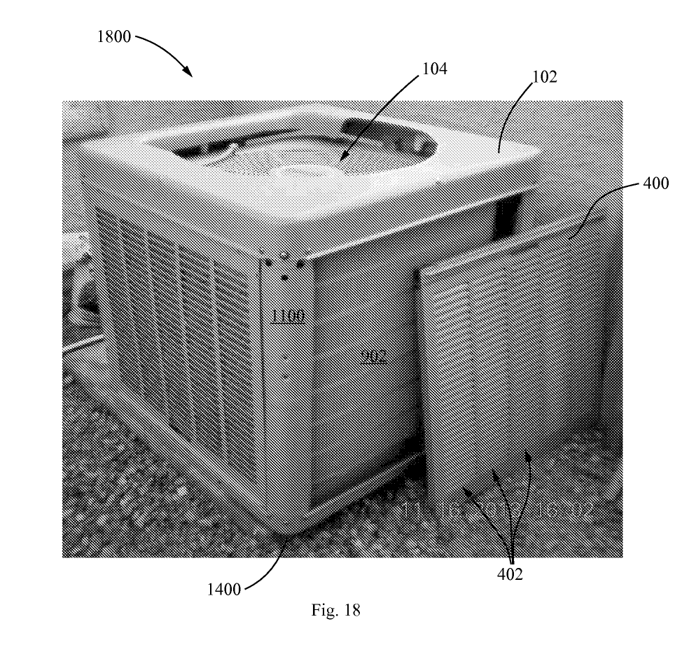

FIG. 18 is a perspective view of an evaporative cooling and refrigerant-based cooling hybrid air conditioning system 1800 in accordance with an example embodiment of the present disclosure.

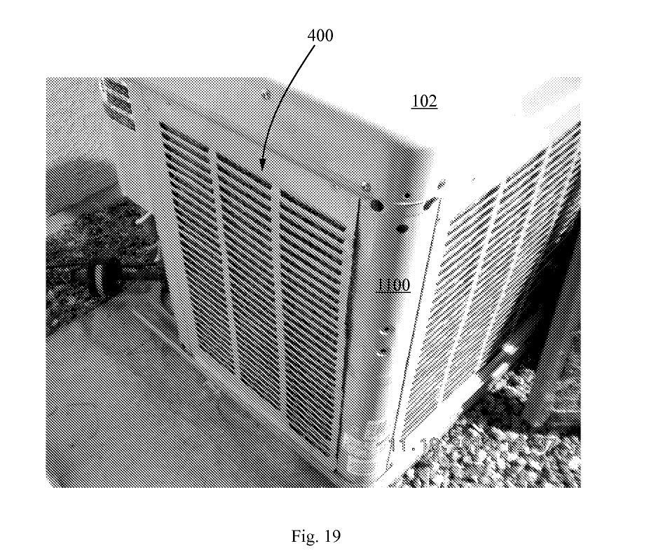

FIG. 19 presents a photo of another view of the second prototype, showing a shortened Cooling Pad Panel 400. In the example embodiment, the Cooling Pad Module 400 is shortened to fit around heat pump piping.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

While the disclosure has been described in terms of various specific embodiments, it will be recognized that the disclosure can be practiced with modification within the spirit and scope of the claims.

The above-described embodiments of a method and system of pre-cooling inlet air to a refrigerant-based air conditioning system provides a cost-effective and reliable means for reducing the electrical power requirements of the refrigerant-based air conditioning system in certain climates. More specifically, the methods and systems described herein facilitate converting an existing refrigerant-based air conditioning system to a hybrid air conditioning system that uses evaporative cooling and refrigerant-based cooling. In addition, the above-described methods and systems facilitate fabricating an evaporative cooling and refrigerant-based cooling hybrid air conditioning system. As a result, the methods and systems described herein facilitate economical cooling of spaces in a cost-effective and reliable manner.

A hybrid air conditioning system exhibits an approximately 30% to 50% reduction in the operating costs and energy consumption the system as compared to the operating costs and energy consumption of a conventional refrigerant-based air conditioning system. The hybrid air conditioning system is estimated to be affordable to most home owners and will not require a replacement of air conditioners already in place. Many users will find that the reduction in electricity consumption will pay for the full cost of this modification in less than two years. There is no need to replace the entire air conditioning system; this is simply a low-cost modification that significantly improves the efficiency of that complete air conditioning system.

Example methods and apparatus for providing an evaporative cooling and refrigerant-based cooling hybrid air conditioning system are described above in detail. The apparatus illustrated is not limited to the specific embodiments described herein, but rather, components of each may be utilized independently and separately from other components described herein. Each system component can also be used in combination with other system components.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A hybrid air conditioning system comprising:
an evaporative cooler cabinet configured to partially surround an outside heat exchanger of an independent air conditioning unit and coupled in serial flow communication with said outside heat exchanger, said evaporative cooler cabinet comprising one or more evaporative cooling panels;
an exhaust fan configured to draw a flow of ambient air through said outside heat exchanger and said one or more evaporative cooling panels; and
a water supply configured to supply water to said one or more evaporative cooling panels while said exhaust fan is operating.

2-12. (canceled)

13. The system of claim 1, wherein said exhaust fan comprises a plurality of air movers comprising at least one of a fan and a blower.

14. The system of claim 1, wherein said evaporative cooler cabinet comprises at least one seam member configured to at least one of join adjacent evaporative cooling panels and join an evaporative cooling panel to a structural member of the air conditioning unit.

15. The system of claim 1, further comprising a water collection trough positioned beneath said one or more evaporative cooling panels, said water collection trough configured to collect excess water from said one or more evaporative cooling panels.

16. The system of claim 1, further comprising a water supply trough positioned proximate an upper end of said one or more evaporative cooling panels, said water collection trough configured to distribute water across a cooling mat associated with said one or more evaporative cooling panels.

17. The system of claim 1, wherein said evaporative cooling panels each comprise a louvered grill covering an upstream face of said evaporative cooling panels.

18. The system of claim 1, wherein said evaporative cooling panels each comprise a cooling mat comprising a fill material covering a surface of the evaporative cooling panels.

19. The system of claim 1, wherein said evaporative cooling panels each comprise a cooling mat comprising wood wool.

20. The system of claim 1, wherein said evaporative cooling panels each comprise an associated water collection trough positioned proximate a bottom end of each said evaporative cooling panel, said water collection trough configured to collect excess water from a cooling mat associated with each said evaporative cooling panel.

21. The system of claim 1, wherein said evaporative cooling panels each comprise an associated water supply trough positioned proximate an upper end of each said evaporative cooling panel, said water collection trough configured to collect excess water from a cooling mat associated with each said evaporative cooling panel.

22. The system of claim 1, further comprising a float valve coupled in series flow with said water supply, said float valve configured to maintain a water level in a distribution reservoir associated with said evaporative cooling panels.

23. The system of claim 1, further comprising a frame circumscribing said evaporative cooling panels, said frame comprising a trough configured to maintain a water level.

24. A method of forming a hybrid air conditioning system, said method comprising:
removing an exhaust fan from an outside heat exchanger of an independent air conditioning unit, the exhaust fan having a first airflow rating;
replacing the exhaust fan with a replacement exhaust fan, the replacement exhaust fan having a second airflow rating, the second airflow rating greater than the first airflow rating;
coupling one or more evaporative cooling panel to the outside heat exchanger spaced from the outside heat exchanger in an upstream direction; and
coupling a supply of water to the evaporative cooling panel.

25. The method of claim 24, further comprising forming a water trough in a frame associated with each evaporative cooling panels.

26. The method of claim 24, wherein coupling a supply of water to the evaporative cooling panel comprises coupling a supply of water to a float valve configured to maintain a water level in a trough associated with the evaporative cooling panel.

27. An air conditioning system conversion kit comprising:
a frame configured to surround an outside heat exchanger of an independent air conditioning unit, said frame comprising:
a cabinet top member comprising an aperture configured to permit a flow of exhaust air therethrough;
a plurality of base members, each comprising a water reservoir;
a plurality of corner struts configured to abut a corresponding one of the plurality of base members;
a plurality of end plug members;
a side support frame configured to couple between adjacent corner struts and to said cabinet top member, said side support frame comprising an aperture, an upper distribution reservoir, and a lower collection trough;
an evaporative cooling panel configured to mount within said aperture of said side support frame, said evaporative cooling panel comprising a planar mat of fill material, said mat of fill material configured to receive a flow of water from said upper distribution reservoir and to permit the flow of water to flow parallel to a plane of said mat by gravity; said mat material configured to receive a flow of air from ambient directed to flow perpendicularly with respect to the mat;
an exhaust fan configured to draw a flow of ambient air through the outside heat exchanger and said mat; and
a water supply configured to supply water to said mats.

28. The system of claim 27, wherein said evaporative cooling panels each comprise a louvered grill covering an upstream face of said evaporative cooling panels.

29. The system of claim 27, wherein said fill material comprises wood wool.

30. The system of claim 27, further comprising a float valve coupled in series flow with said water supply, said float valve configured to maintain a water level in a trough associated with said evaporative cooling panels.
